(19) United States
(12) Patent Application Publication
(10) Pub. No.: US 2023/0264339 A1
(43) Pub. Date: Aug. 24, 2023

(54) VISUAL ALIGNMENT SYSTEM FOR ROTARY BORING TOOLS

(71) Applicant: John Cerwin, Gurnee, IL (US)

(72) Inventor: John Cerwin, Gurnee, IL (US)

(21) Appl. No.: 18/017,369

(22) PCT Filed: Jul. 22, 2021
(86) PCT No.: PCT/US2021/042816

§ 371 Date: Jan. 20, 2023

Related U.S. Application Data
(60) Provisional application No. 63/055,076, filed on Jul. 22, 2020.

(51) Int. Cl. B25F 5/02; B23B 49/00

(52) U.S. Cl. CPC B25F 5/021; B23B 49/00; B23B 2260/092

(57) ABSTRACT

A device and system for a rotary boring tool that enables a user to visually align the tool with respect to a target worksurface is disclosed. The alignment system includes a worksurface alignment device that is mounted onto the non-rotating portion of a rotary boring tool that includes one or more focused light sources, such as a laser, that projects a linear or nonlinear shaped beam and produces a visible pattern on the worksurface that indicates alignment or misalignment of the rotary boring tool with respect to the worksurface. Systems optionally includes a user display that works independently or in combination with one or more sensors to provide additional information about the rotary boring operation, and a wireless communication device that is enables wireless communication with other computing devices directly or through a network of computing devices.

### REFERENCE TO RELATED APPLICATIONS

The Applicant claims the benefit of the filing date of U.S. Application No. 63,055,076 filed on Jul. 22, 2020.

### FIELD OF INVENTION

The present invention is directed to rotary boring tool alignment systems.

### BACKGROUND OF THE INVENTION

Accurate rotary boring operations are important in many fields including the construction, manufacturing, aerospace, and medical industries. Every rotary boring operation, such as hand-held drilling, requires the user to align the rotary boring tool with reference to a worksurface both prior to and during the drilling operation. If the drill is misaligned at any point in the operation, the drill hole will also be misaligned. Therefore, successful hole or cavity boring is only possible if alignment can be obtained at both stages of the boring operation (before initiation of the operation and during the operation).

There is a continuing need for an apparatus or system that helps a user to establish correct alignment with a worksurface prior to a drilling operation. Further, there is an equally important continuing need for an apparatus or system that helps a user to maintain correct alignment of a rotary boring tool with a worksurface during drilling operations.

### BRIEF DESCRIPTION OF THE INVENTION

The present invention is directed to precision rotary boring tool alignment systems. In various embodiments of the invention a visual alignment apparatus or system for rotary boring tools is provided to improve both the functionality and usability of rotary boring tools. Such rotary boring tools include but are not limited to handheld-power drills, manual drills, stationary drill presses, smaller rotary tools such as Dremel® tools, other types of rotating machinery such as milling machines and lathes, as well as larger boring devices such as earth or natural resource boring machinery. In addition, the system can be used on or about any object that must be visually aligned or oriented with another plane, such as a worksurface at 90 degrees with reference to the object, or simply a working plane at an angle other than 90 degrees with reference to the object.

The system of the invention includes a worksurface facing alignment device that includes one or more focused light sources, such as a laser, that projects a linear or nonlinear shaped beam and produces a visible pattern on the worksurface that indicates alignment or misalignment of the rotary boring tool with respect to the worksurface. In one embodiment, the worksurface alignment device is mounted on a non-rotational part of the rotary tool in line with the rotational axis of the rotary tool. In another embodiment, the worksurface facing alignment device is mounted on or about an alternative non-rotational part of the rotary tool that is not in line with rotational axis of the rotary tool.

An advantage of the system is that it enables a user to visually align the tool with respect to a target worksurface both prior to and during boring operations thus allowing the user to start and complete a drilling operation in perfect alignment with the worksurface. Further, since the system is based on projected light, there is no need for a physical connection to align the worksurface and the drill, or between the worksurface and any part of the drill.

In various embodiments the system may also include different drill brand or model adapters to connect with the alignment system, different drill chuck size and length implementations, different worksurface alignment patterns, different power or battery configuration options, integration of a visual display and/or audible notification system with the drill, integration of a sensor or set of sensors that provide additional assistance in the rotary boring operation (such as drill bit depth visualization, drill bit or worksurface temperature detection sensors, or temperature visualization, drill bit usage information, sub-surface object indication or visualization, boring tool operating characteristics such as rotational speed or drill motor temperature). The worksurface facing alignment device adaptor and may also operate as a modular interchangeable system. In this case, an adaptor second device that mounts onto the non-rotational portion of a drill may be designed for specific drill brands or models but still possess a universal adapter that can connect to work with a variety of worksurface facing alignment devices, each of which may possess unique characteristics such as different worksurface alignment patterns, sensors, etc. Further, the modular system may be expanded to include additional elements (that can be optionally added and removed) such as a drill stop that optionally mounts to or about the worksurface facing alignment device and prevents drilling beyond a certain depth.

### BRIEF DESCRIPTION OF THE DRAWINGS

FIG. 1 is a perspective view of a drill alignment device mounted to the non-rotational portion of the drill.

FIG. 2 is a perspective view of the alignment device depicted in FIG. 1, but in this case the drill is misaligned to the right on a horizontal x axis, with regards to the worksurface, and a corresponding misaligned projection pattern is depicted on the worksurface.

FIG. 3 is a perspective view of the alignment device depicted in FIG. 1, but in this case the drill is misaligned upward vertical axis with regards to the worksurface, and a corresponding misaligned projection pattern is depicted on the worksurface.

FIG. 4 is a side view in elevation of an alignment system that that includes a first worksurface facing alignment device and a second adaptor device that is mounted temporarily or permanently on the non-rotating portion of the drill.

FIG. 5 is an exploded side view in elevation of the system depicted in FIG. 4.

FIG. 6 is a perspective side view of worksurface alignment device and an adaptor device that can be mounted temporarily or permanently on the non-rotating portion of a drill.

FIG. 7 is a sectional view in elevation of the worksurface alignment device and the adaptor device of FIG. 6.

FIG. 8 is a sectional view in elevation of worksurface alignment device of FIG. 7.

FIG. 9 is a sectional view in elevation of the of the worksurface alignment device depicted in FIG. 8 with fan shaped laser beams visibly projected at a worksurface.

FIG. 10 depicts an example of an aligned projection pattern on a worksurface.

FIG. 11 depicts an example of a projection pattern on a worksurface from the alignment device when the boring tool is horizontally misaligned.

FIG. 12 depicts an example of a projection pattern on a worksurface from the alignment device when the boring tool is vertically misaligned.

FIG. 13A is a schematic side view of a single laser and beam splitter creating an alternative projection pattern that creates the projection pattern in FIGS. 14, 15, and 16.

FIG. 13B depicts a beam splitter device that splits four beams and creates the projection pattern in FIGS. 14, 15, and 16.

FIG. 13C depicts a side view of the beam splitter of FIG. 13B that splits each of four beams from the alignment device individually and creates the projection pattern in FIGS. 14, 15, and 16

FIG. 14 is an alternative projection pattern with an alternative alignment device when a rotary boring tool is oriented perpendicular to a work surface.

FIG. 15 is a projection pattern from the alternative alignment device of FIG. 14 when the rotary tool is misaligned on a horizonal axis with reference to the worksurface.

FIG. 16 is a projection pattern from the alternative alignment device of FIG. 14 when the rotary tool is misaligned on a vertical axis with reference to the worksurface.

FIG. 17 is a schematic view of a further embodiment of an alignment device that comprises a single laser and dual beam splitter that creates the projection pattern in FIGS. 18 and 19.

FIG. 18 is projection pattern that contains two alternatively angled lines in each side of the projection pattern when the alignment device is directly perpendicular to the work surface.

FIG. 19 uses the same alignment device as in FIG. 18 that from when the drill is not perpendicular but misaligned on a horizonal axis with reference to the worksurface.

FIG. 20 is a side view in elevation of a three-part modular system including an alignment member, a spacer member that fits over the rotating portion of a drill, and an adaptor that is configured to be mounted on a non-rotating portion of a drill.

FIG. 21 Is a front view in elevation of an alignment member with that includes an additional sensor.

FIG. 22 is a perspective view of an alignment member that contains a visual display on the alignment device that can provide feedback to the user based on a one or more inputs.

FIG. 23 depicts a worksurface projection emanating from an alternative non-rotational location on a drill that is not concentric with boring element.

FIG. 24 depicts a display from an alternative alignment device that projects both a worksurface alignment pattern and additional information and data onto a worksurface.

FIG. 25. depicts a further embodiment of a system including an alignment device that contains a wireless communication transmitter and receiver and peripheral devices.

FIG. 26. depicts a further embodiment of a system that includes an alignment device that is in wireless communication with a central control device that can transmit instructions to and receive data from an alignment device.

FIG. 27. depicts an alignment device used to assess the accuracy of a drilled hole.

### DETAILED DESCRIPTION OF PREFERRED EMBODIMENTS

The system of the invention includes a worksurface alignment device that includes one or more focused light sources, such as a laser, that projects a linear or nonlinear shaped beam and produces a visible pattern on the worksurface that indicates alignment or misalignment of the rotary boring tool with respect to the worksurface.

An advantage of the system is that it enables a user to visually align the tool with respect to a target worksurface both prior to and during boring operations thus allowing the user to start and complete the drilling operation in perfect alignment with the worksurface. Further, since the system is based on projected light, there is no need for a physical connection between the worksurface and the drill, or between the worksurface and any member of the system. Moreover, the system does not require or rely on any rotational aspects of the rotary boring tool.

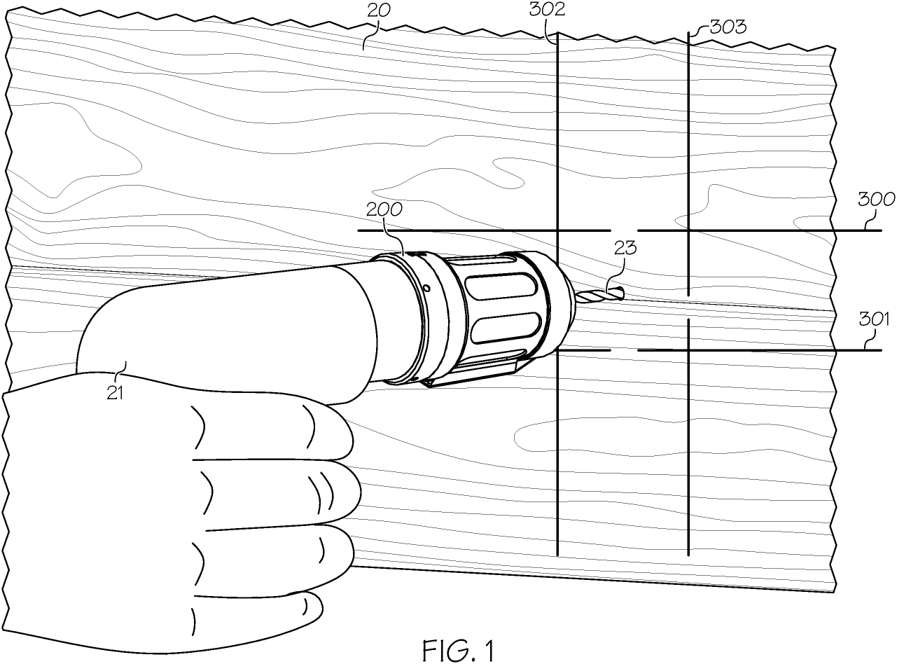

In the embodiment depicted in FIG. 1, the worksurface alignment device is a single member 200 that is mounted on a non-rotational part of the rotary tool 21. In this figure the pattern projected on worksurface 20 is comprised of four linear projections 300, 301, 302, 303 that jointly produce a grid pattern. The grid pattern consists of two vertical linear projections 302, 303 and two horizontal linear projections 300, 301. When the rotational axis of the rotary tool 21, which in FIG. 1 is the drill bit 23, is aligned perpendicular to the worksurface, the projected grid pattern is fully symmetrical. A fully symmetrical grid pattern reflects that the two linear pairs, which are the two vertical linear projections 302, 303 and the two horizontal linear projections 300, 301, are parallel to each other and the same length. For example, in FIG. 1 the two vertical linear projections 302, 303 are both parallel to each other and are the same length, as are the two horizontal linear projections 300, 301. Alignment is also indicated by the perfect square in the center that surrounds drill bit 23. This square is jointly produced by the symmetry of the two vertical linear projections 302, 303 and the two horizontal linear projections 300, 301. The combined symmetry of the worksurface projections provides the rotary tool user with an indication of alignment both before and during the drilling operation.

In the embodiment depicted in FIG. 1, the alignment device 200 is mounted in line with the rotational axis of the rotary tool. In FIG. 1, the drill is perpendicularly aligned with the worksurface, and the aligned projection pattern is depicted on the worksurface. In line alignment allows the four linear projections 300, 301, 302, 303 on the worksurface 20 to be equally distributed around the drill bit 23 when the rotary tool is aligned with the worksurface 20. The alignment device 200 also contains an open passage in the center that allows the drill bit to rotate without obstruction.

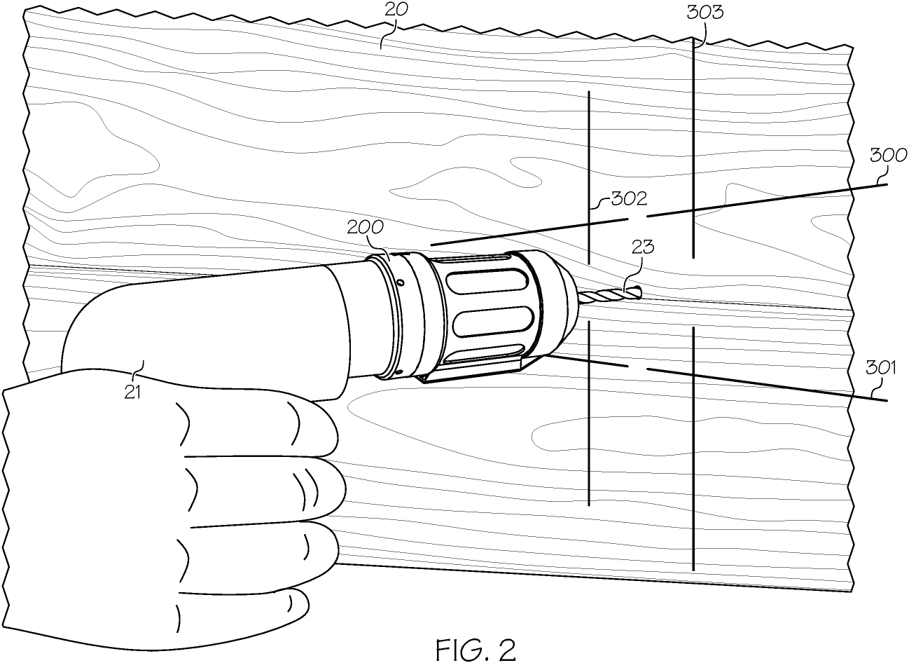

FIG. 2 depicts the same alignment device 200 embodiment from FIG. 1, but in this case the rotary tool is misaligned along the horizontal axis with regards to the worksurface (the rotary tool is pointed slightly right). As a result of the horizontal misalignment, the two horizontal linear projections 300, 301 are no longer parallel, which makes the projected grid non-symmetric and the center square trapezoidal. Further the two vertical linear projections 302, 303 are no longer the same length. This combined dissymmetry of the worksurface projections provides the rotary tool user with an indication of misalignment of the drill (pointing to the right along the horizontal axis). This is detectable both before and during the drilling operation.

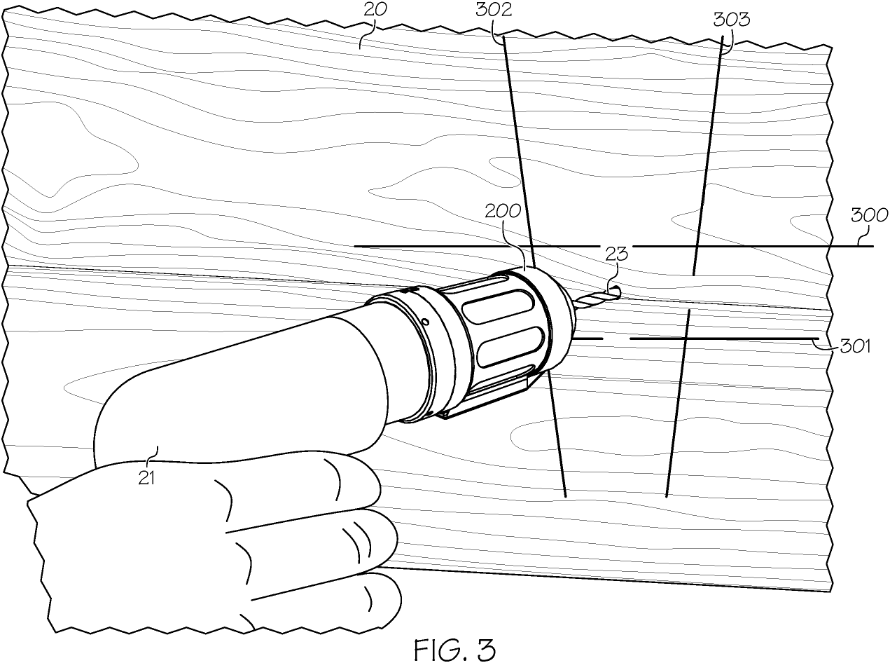

FIG. 3 depicts the same alignment device 200 embodiment from FIG. 1, but in this case the rotary tool is misaligned along the vertical axis with regards to the worksurface (the rotary tool is pointed slightly up). As a result of the vertical misalignment two vertical linear projections 302, 303 are no longer parallel, which makes the projected grid non-symmetric and the center square trapezoidal. Further the two horizontal linear projections 300, 301 are no longer the same length. This combined dissymmetry of the worksurface projections provides the rotary tool user with an indication of misalignment of the drill (pointing up along the vertical axis). This is detectable both before and during the drilling operation.

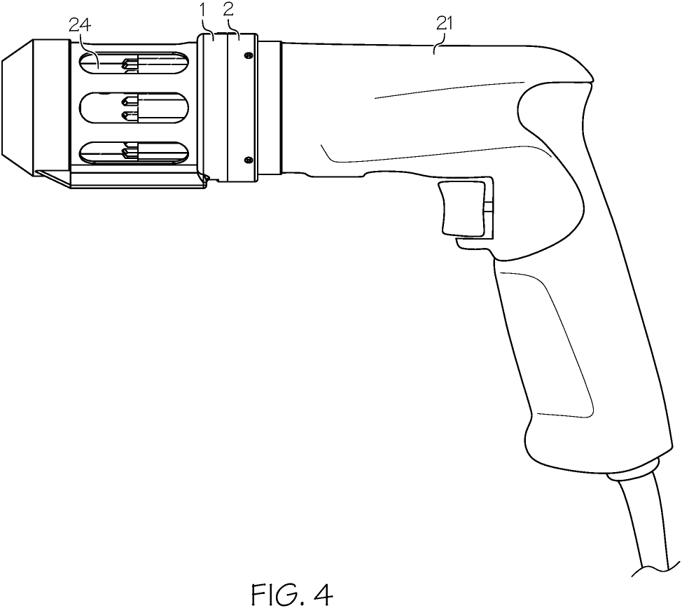

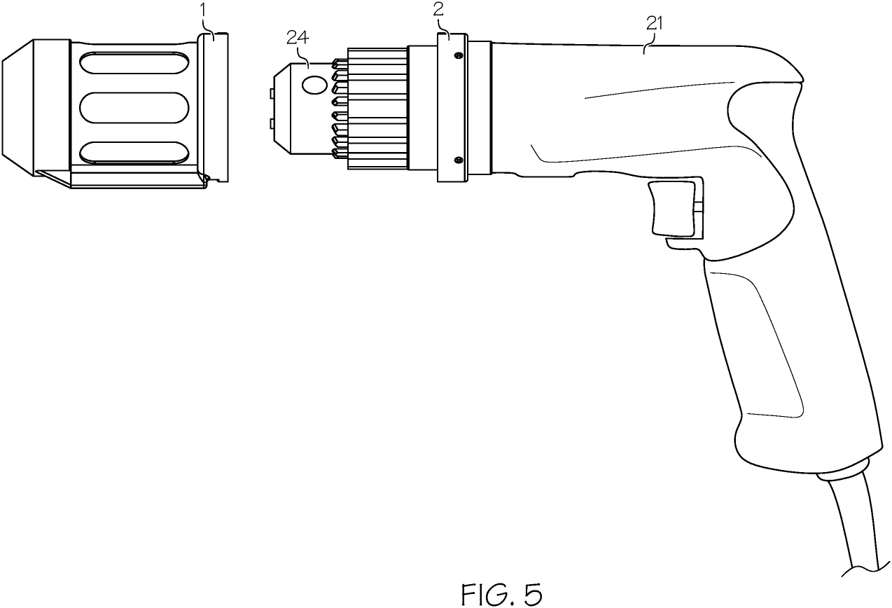

FIG. 4 depicts another embodiment that consists of two separate parts, an alignment device 1 and an adaptor device 2 that can be easily connected to create a single operational apparatus with functionality and characteristics identical to FIGS. 1, 2 and 3. In this embodiment, the first member 1 is the worksurface alignment device, and the second member 2 is an adaptor device that mounts permanently or temporarily onto the non-rotational part of the rotary tool 21. FIG. 4 depicts the two parts 1 and 2 connected, while FIG. 5 depicts the two parts 1 and 2 disconnected.

The two-part system depicted in FIGS. 4, 5, 6, 7, 8 and 9 provides several advantages over the alignment device depicted in FIGS. 1, 2 and 3.

First, the two-part system allows for rapid access to a drill chuck 24 by simply disconnecting the worksurface alignment device 1 from the second adaptor device 2 (which mounts permanently or temporarily onto the non-rotational part of the rotary tool 21). Rapid access to the drill chuck 24 is necessary for normal drilling operations such as drill bit changes or drill bit tightening or loosening.

Second, the two-part system allows for integration with a wide variety of rotary tool brands or brand models. In one or more embodiments, there are specific versions of the adaptor device designed to mount to specific rotary tool brands or brand models. Each of the adaptors can further support a universal connection mechanism for connecting to a worksurface alignment device. This allows worksurface alignment device to work with many different adaptors, and thus many rotary tool brands or brand models.

Third, since the two-part system utilizes a universal connection mechanism, several versions of a worksurface alignment device with differing functionality may also be integrated. This would create a system of fully compatible and interchangeable worksurface alignment devices and adaptor devices that can be mixed and matched. In such embodiments, the variation of functionality offered in the worksurface alignment device include, but is not limited to, different laser projection characteristics (such as color, strength, or projection pattern), different power or battery options, different sizes or shapes that allow for use with different size or shaped drill chucks, or integration of different types of sensors that further extend the functionality of the worksurface alignment device.

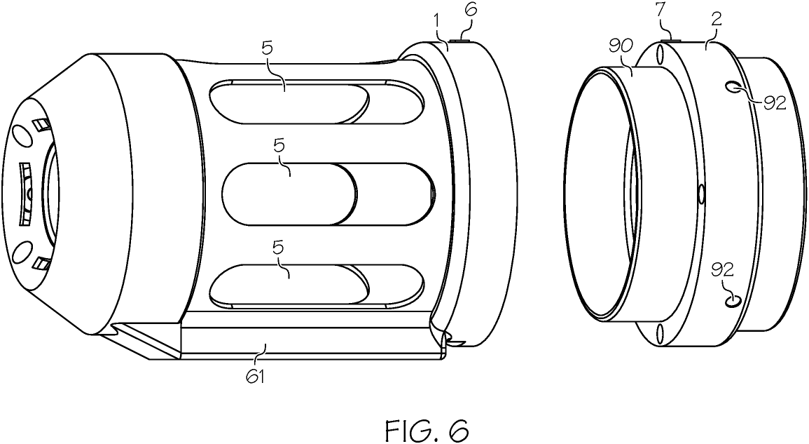

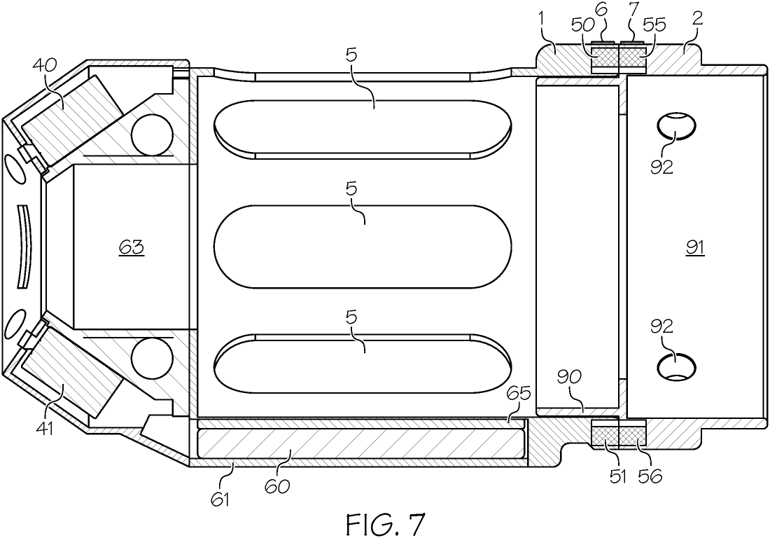

FIGS. 6 and 7 depict the embodiment of the two-part system as also shown in FIGS. 4 and 5. The embodiment includes a worksurface alignment device 1 and an adaptor device 2 which mounts permanently or temporarily onto the non-rotational part of a rotary tool. FIG. 6 depicts a side view of the two-part system as disconnected, and FIG. 7 depicts a sectional view of the two parts of the system as connected. Similar to the embodiment in FIGS. 1, 2, and 3, this embodiment also contains an open passage 63 that allows the drill bit to rotate without obstruction.

In the embodiment depicted in FIG. 7, a two-part system, the worksurface alignment device 1 contains linear laser modules 40, 41. Not shown are two additional lasers in alignment device 2 that are used to create linear projections on worksurfaces. Each of linear laser modules, such as laser 40 and 41, is associated with an embedded lens that converts a standard dot or ellipse-shaped laser beam (cross section) into a fan shaped pattern. The embedded lenses for beam conversion are well known in the art. Worksurface alignment device 1 also contains battery 60, battery compartment 61, printed circuit board 65 that contains electronic components, and a switch means (not shown) for toggling the laser projections on or off. The toggle switch of the embodiment of FIG. 7 is a power switch. In other embodiments, the switch may be activated by a motion sensor or a drill rotation sensor.

The worksurface alignment device 1 also includes an alignment indicator or notch 6 that, when attached to the adaptor device 2, is aligned with the adaptor device 2 alignment indicator or notch 7. Alignment of the alignment device and adaptor device alignment indicators provides a user with confirmation that the system is connected correctly.

The two-part system’s worksurface alignment device 1 also contains one or more open sections 5 around its circumference for exposure of a drill chuck. These open sections 5 can serve several independent or concurrent purposes including but not limited to access to the chuck (and specifically the keyhole for keyed chucks), operator visualization of the chuck state (such as rotational status and speed), and/or aesthetics.

A further feature of the two-part system as depicted in FIG. 7, is that each part contains a set of opposing magnets that are arranged so that the magnets 50, 51 in the worksurface alignment device 1 are attracted to the magnets 55, 56 in the adaptor device 2. The use of magnets allows the parts to be securely connected, but also quickly disconnected. Moreover, the magnets allow the worksurface alignment device 1 to be automatically, consistently, and repeatedly aligned with the adaptor device 2 which is itself aligned with reference to the drill body. In another embodiment, each member of the system can contain magnets of varying strengths or counts to make the connection as strong or weak, as necessary. Further, in yet another embodiment, the system may use a combination of magnets and ferrous materials to create the connection between a worksurface alignment device and adaptor device.

Other embodiment of adaptor members contains a mechanical means for connecting or aligning the two parts. Referring now to FIGS. 6 and 7, a mechanical alignment guide 90 in adaptor device 2 is shown that slides into the inner body of worksurface alignment device 1. This assists with quick and consistent alignment of the two parts. In other embodiments, the two-part system is connected solely through mechanical means and without magnets. The mechanical means for connecting the two parts can be anything known in the art including but not limited to a threaded connection, twist-lock connection, or clamping connection.

Adaptor device 2 further contains screw holes or threaded slots 92 that allow the adaptor device 2 to be securely attached to a rotary tool. Alternative adaptor devices are designed to slide or mount tightly onto the circumference or outer shape of a rotary tool. The means for securely attaching the adaptor member to a rotary tool can be anything known in the art including but not limited to a clamping attachment or pressure fit attachment.

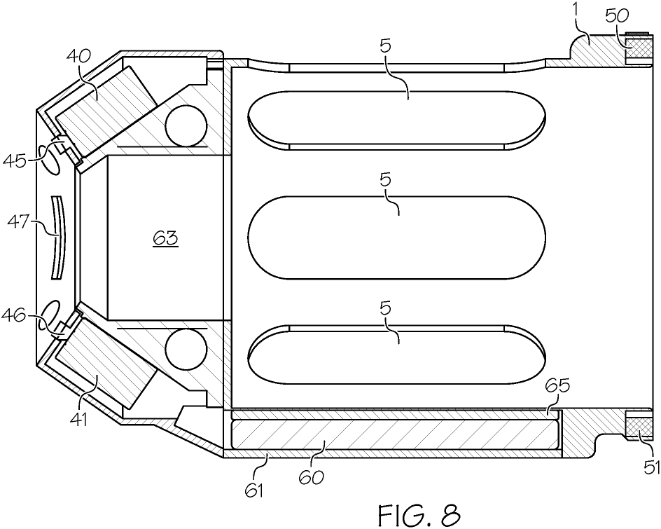

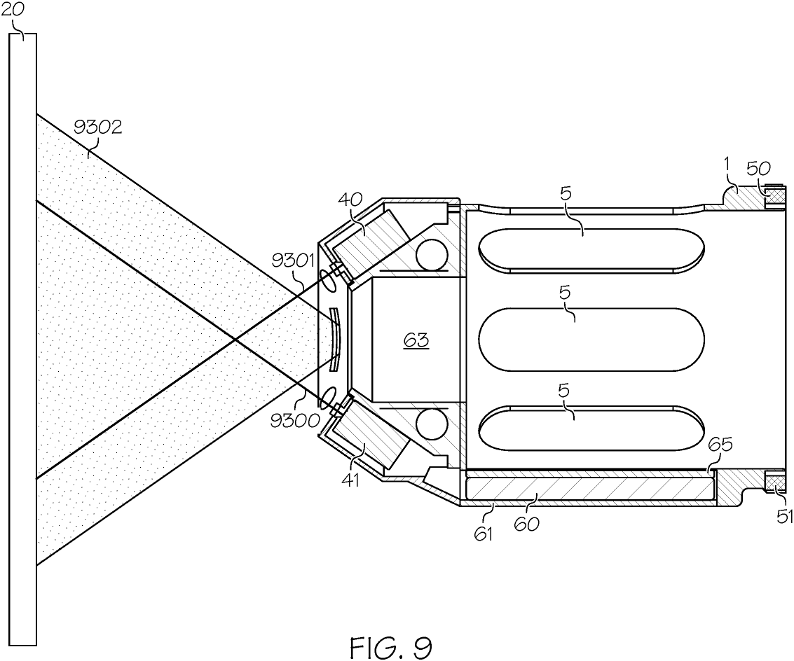

FIGS. 8 and 9 depict the worksurface alignment device 1 of the two-part system as depicted in FIGS. 4, 5, 6, and 7. Referring now to FIG. 8, worksurface alignment device 1 contains open ports 45, 46, 47, for the laser modules. wherein port 45 is provide for laser 40, port 46 is provide for laser 41. As seen in FIG. 9 the lasers emit fan shaped projections 9300, 9301, 9302. Not shown is fourth projection. Ports 45, 46, 47 include a transparent window material that the projections 9300, 9301, and 9302 can pass through.

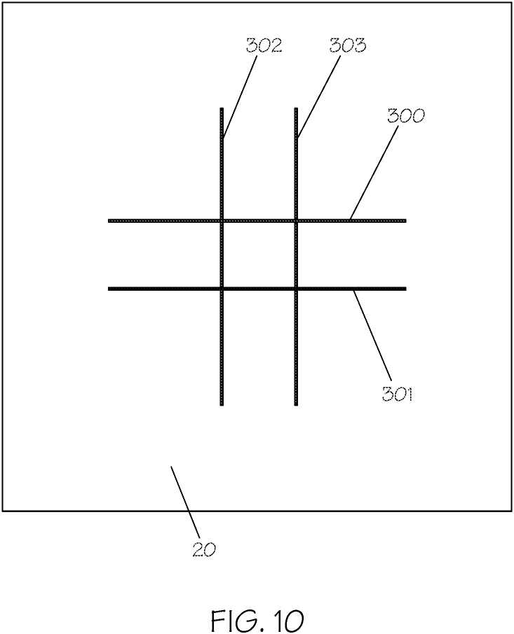

As seen in FIG. 9, the laser modules 40, 41, 42 are angled about and with reference to a central longitudinal axis though the member. The angled lasers serve to amplify the indication of misalignment of the projected pattern on a worksurface. The linear projections 9300, 9301, and 9302, in FIGS. 10, 11 and 12, and the projections shown in FIGS. 1, 2, 3, are all produced through angled lasers similar to that shown in FIG. 9.

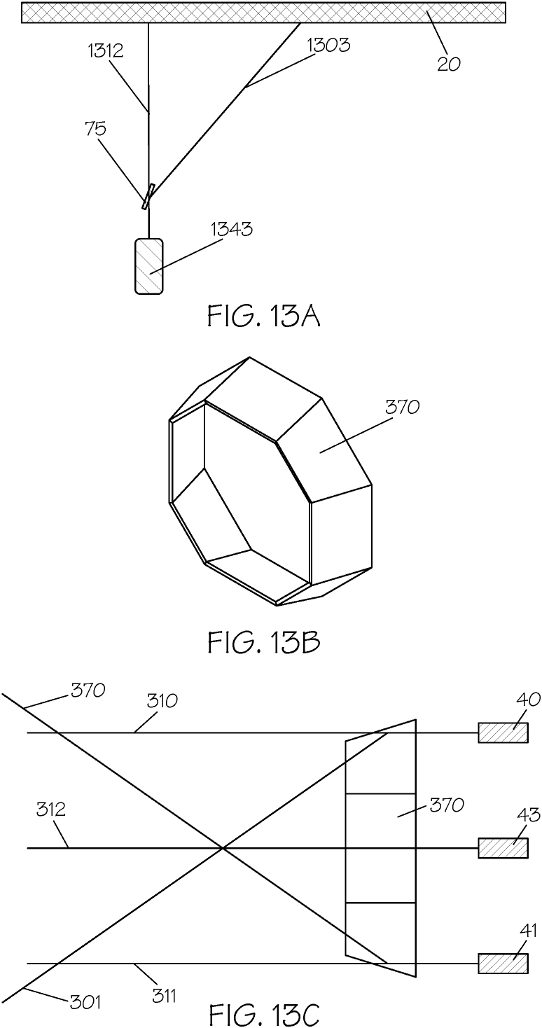

The angle of the laser disclosed in FIG. 9 is fixed. In other embodiments, the angle may be variable and controlled by the user. In further embodiments, the angle of the laser projection may be controlled by an optical element, such as beam splitter 75 of FIG. 13A, a mirror, a prism, an optical lens or element, a diffractive optical element, or some combination thereof.

Laser modules used for alignment devices, such as 40, 41, and 42 may use different types of embedded or external lenses or beam shaping optics, such as diffractive optical elements (DOEs). In such embodiments the projected laser patterns on a worksurface may also be linear dot shaped or nonlinear.

In other embodiments, fewer than four projections may be employed. For example, instead of four projections (two vertical and two horizontal) that form a grid pattern, the embodiments may only employ a single linear vertical projection and a single linear horizontal projection or three projections that produce a triangular pattern on a worksurface.

FIG. 10 depicts the worksurface pattern produced by the embodiments in FIGS. 1 to 9 when the drill is aligned with reference to the worksurface 20. In FIG. 10 the pattern projected on the worksurface 20 is comprised of four linear projections 300, 301, 302, 303 that jointly produce a grid pattern. The grid pattern consists of two vertical linear projections 302, 303 and two horizontal linear projections 300, 301. When the rotational axis of the rotary tool 21, which in FIG. 1 is the drill bit 23, is aligned perpendicular to the worksurface 20, the grid pattern is fully symmetrical. This is detectable both before and during the drilling operation.

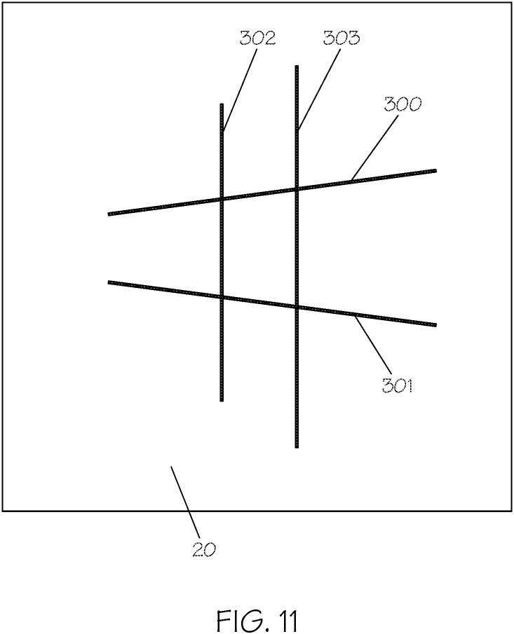

FIG. 11 depicts a worksurface pattern produced by the embodiments in FIGS. 1 to 9 when the drill is horizontally misaligned with reference to the worksurface 20. In this case the rotary tool is not perpendicular with the worksurface but misaligned and out of the XZ Plane that extends through the point that the Z axis, referenced as the contact point of the drill on a worksurface (the rotary tool is pointed slightly right with regard to the worksurface 20). As a result of the misalignment from the XZ plane, the two horizontal linear projections 300, 301 are no longer parallel, which makes the projected grid non-symmetric and the center square trapezoidal. Further the two vertical linear projections 302, 303 are no longer the same length. This combined dissymmetry of the worksurface projections provides the rotary tool user with an indication of misalignment of the drill pointing to the right along the horizontal axis. This is detectable both before and during the drilling operation.

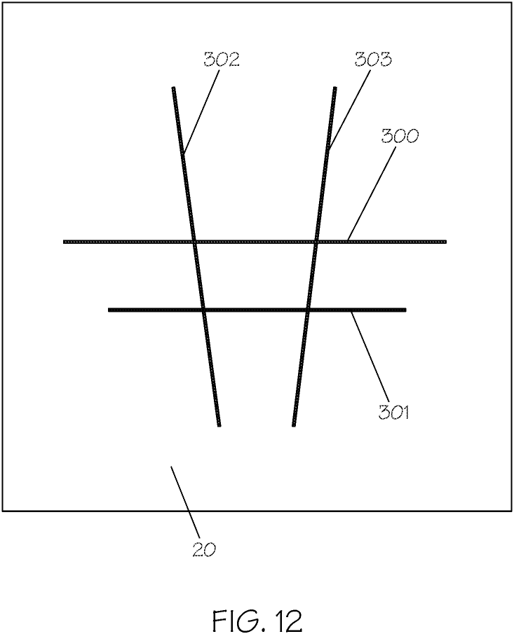

FIG. 12 depicts the worksurface pattern produced by the embodiments in FIGS. 1 to 9 when the drill is vertically misaligned with reference to the worksurface 20. In this case the rotary tool is not perpendicular with the worksurface but misaligned from a YZ plane intersection the worksurface 20. As a result of the misalignment from the YZ plane, the two vertical linear projections 302, 303 are no longer parallel, which makes the projected grid non-symmetrical, and the center of the grid is trapezoidal. Further the two horizontal linear projections 300, 301 are no longer the same length. This combined dissymmetry of the worksurface projections provides the rotary tool user with an indication of misalignment of the drill pointing up along the vertical axis. This is detectable both before and during the drilling operation.

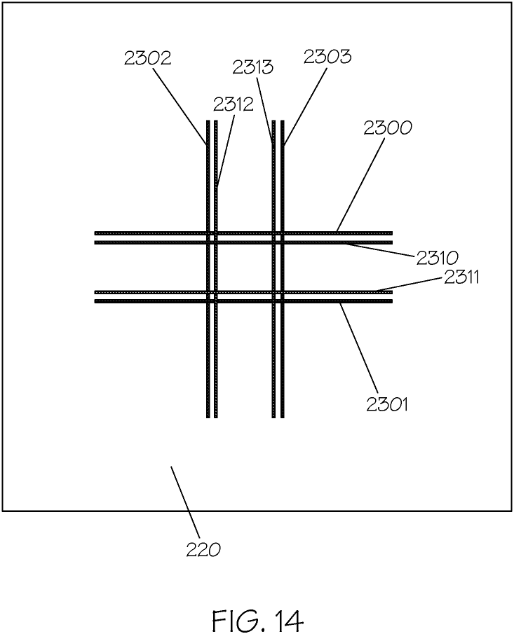

FIG. 13A depicts a side view of an alternative laser configuration. In this embodiment, the angled laser projection is not created by the laser itself, but by the angle of a beam splitter 75 that splits the single linear laser projection from laser module 1343 into two independent linear laser projections 1312 and 1303. Although only a single laser module 1343 and beam splitter 75 are shown in FIG. 13A, an implementation could have four linear laser modules and four corresponding and independent beam splitters that in combination, result in the patterns shown in FIGS. 14, 15 and 16. As shown in previous embodiments, these four linear laser modules and splitters are equally distributed around the rotational axis of the rotary tool at the 12, 3, 6 and 9 o′clock positions.

In the embodiment depicted in FIG. 13B, the beam splitter is a single member 370 (instead of four independent beam splitters) that splits each of the four beams individually. This embodiment creates a projected worksurface pattern that is the same as or similar to the pattern from the four independent beam splitters depicted in FIGS. 14, 15, and 16. This embodiment is advantageous because a single member 370 is typically easier to manufacture, install and align. Single member 370 is designed to be adjustable along the X, Y, or Z axis within the system for purposes of calibration or alteration of the projection pattern.

FIG. 14 depicts a worksurface pattern produced by the laser configuration with four lasers surrounding an axis of rotation on and four corresponding and independent beam splitters when the drill is perpendicularly aligned with reference to worksurface 220. In this figure, the pattern projected on the worksurface is a grid comprised of eight linear projections 2300, 2301, 2302, 2303, 2310, 2311, 2312, 2313 on the worksurface 120 that jointly produce a grid pattern. The grid pattern consists of four vertical linear projections 2302, 2303, 2312, 2313 and four horizontal linear projections 2300, 2301, 2310, 2311. When the rotational axis of a rotary tool, such as drill bit 23 as that depicted in FIG. 1 is perpendicularly aligned to the worksurface 220, the grid pattern is fully symmetrical.

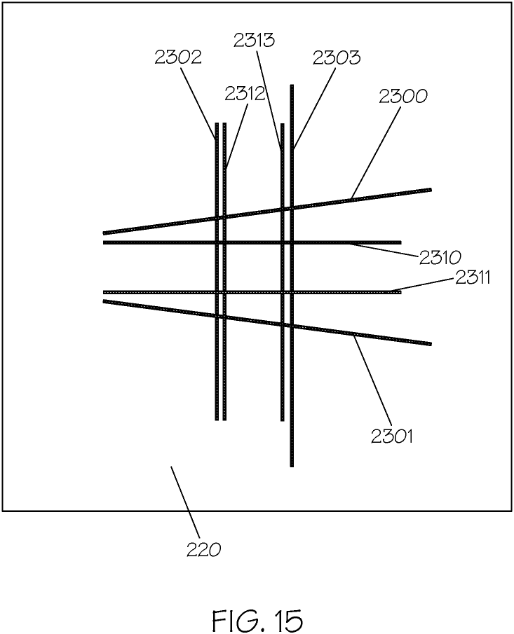

FIG. 15 depicts the worksurface pattern produced by four linear laser modules, and four corresponding and independent beam splitters when the drill is misaligned and outside of a XZ plane that is perpendicular to the work surface and intersecting with a contact point of the drill on the worksurface 220. In this case the rotary tool is not perpendicular with the work surface but misaligned from a the XZ plane intersecting the worksurface (the rotary tool is pointed slightly right). As a result of a misalignment, the two linear projections 2300, 2301 are no longer parallel, which makes the projected grid non-symmetric. The advantage of this embodiment is that the other two linear projections 2310, 2311 remain essentially parallel to each other and essentially the same length regardless of the foregoing misalignment. The two linear projections 2310, 2311 thus provide a stable reference pattern that can be used in comparison to the other two linear projections 2300, 2301 that become angled and non-parallel with misalignment. Further the two linear projections 2302, 2303 are no longer the same length. This combined dissymmetry of the worksurface projections provides the rotary tool user with an indication of misalignment of the drill (in this case pointing to the right outside of the horizontal plane). This is detectable both before and during the drilling operation.

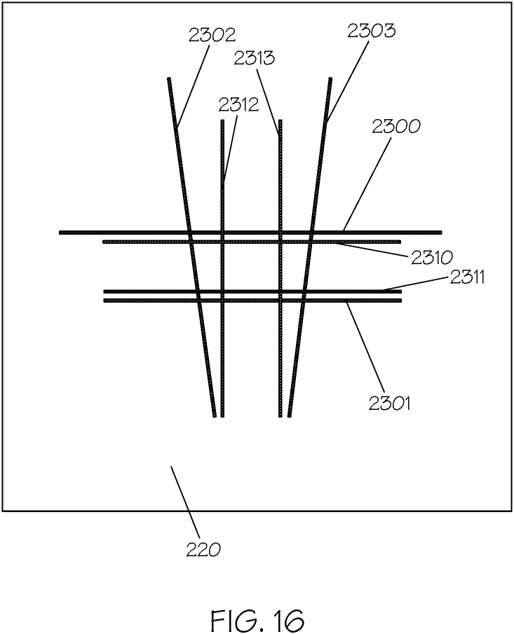

FIG. 16 depicts worksurface pattern produced by four linear lasers modules and four corresponding and independent beam splitters when the drill is vertically misaligned with reference to the worksurface 220. In this case the rotary tool is misaligned from a YZ plane that is perpendicular to both the XZ and XY plane, with regard to worksurface 220. As a result of the misalignment from the YZ plane, the two vertical linear projections 2302, 2303 as they appear on FIG. 16 are no longer parallel, which makes the projected grid non-symmetric. The advantage of this embodiment is that the other two linear projections 2312, 2313 remain essentially parallel to each other and essentially the same length regardless of misalignment from the YZ plane. These two linear projections 2312, 2313 thus provide a stable vertical reference pattern that can be used in comparison to the two linear projections 2302, 2303 that become angled and non-parallel with misalignment. Further the two linear projections 2300, 2301 are no longer the same length. This combined dissymmetry of the worksurface projections provides the rotary tool user with an indication of misalignment of the drill (in this case pointing up along the vertical axis). This is detectable both before and during the drilling operation.

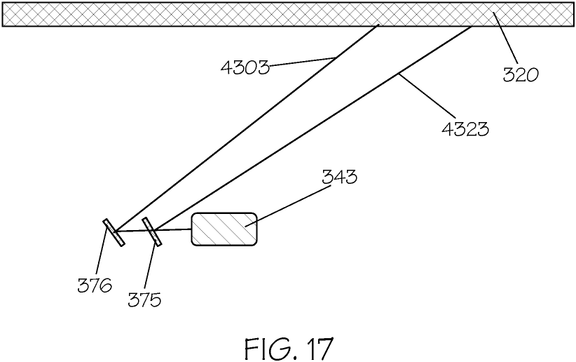

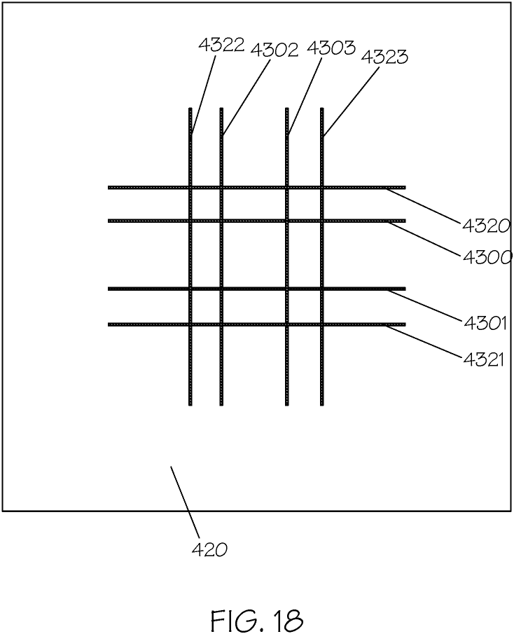

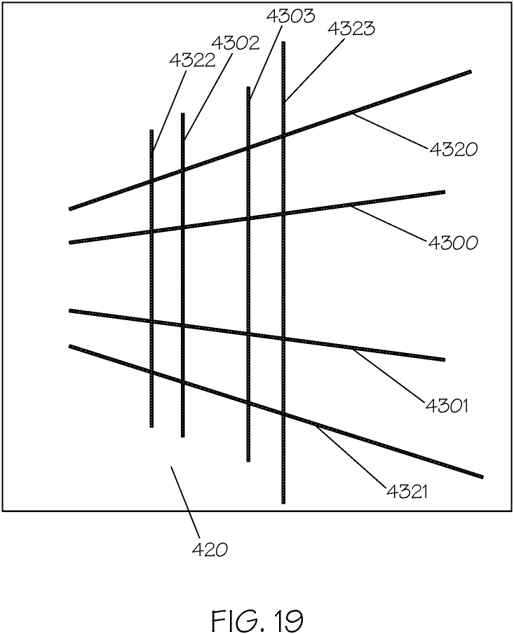

FIG. 17 depicts a top view of another alternative laser configuration and resulting pattern projection. In this embodiment, the light beam is split and reflected twice which produces two angled linear projections. In this embodiment, the angled laser projection is not created by the laser 343 itself, but by a combination of beam splitter 375 and mirror 376. The combination of these two optical elements splits the single linear laser projection from laser module 343 into two independent linear laser projections 4303 and 4323 that emanate at different angles towards surface 420. Although only a single laser module 343, beam splitter 375, and mirror 376 are shown in FIG. 17, contemplated implementations will have four laser modules and four corresponding and independent beam splitters and mirrors that in combination result in the patterns shown in FIGS. 18 and 19. As shown in previous embodiments, these four laser modules (which produce fan-shaped projections), splitters and mirrors are equally distributed around the rotational axis of the rotary tool at the 12, 3, 6 and 9 o′clock positions.

FIG. 18 depicts the worksurface pattern produced by the split laser devices describe above with four linear laser modules, four corresponding and independent beam splitters, and four corresponding and independent mirrors when the drill is perpendicularly aligned with reference to the worksurface 420. In this figure the pattern projected on the worksurface is a grid comprised of eight linear projections 4300, 4301, 4302, 4303, 4320, 4321, 4322, 4323 on worksurface 420 that produce a grid pattern. The grid pattern consists of four vertical linear projections 4302, 4303, 4322, 4323, and four horizontal linear projections 4300, 4301, 4320, 4321. When the rotational axis of a rotary tool drill bit is perpendicularly aligned with regard to the worksurface, the grid pattern is fully symmetrical.

FIG. 19 depicts the worksurface pattern produced by the same laser configuration of FIG. 17 when the drill is misaligned with reference to the XZ plane intersecting the worksurface 420. In this case the rotary tool is not perpendicular with the work surface but misaligned from a the XZ plane intersecting the worksurface (the rotary tool is pointed slightly right). As a result of the misalignment, the four horizontal linear projections 4300, 4301, 4320, 4321 are no longer parallel, which makes the projected grid non-symmetric. The advantage of this embodiment is that the other two horizontal linear projections 4320, 4321 are projected out at angles greater than horizontal linear projections 4300 and 4301, and this provides an indication of misalignment earlier than linear projections 4300 and 4301. Moreover, the two sets of angled projections on each axis allows for use of a wider range of drill bit lengths as at least one set of angled projections is always close to the drill bit and thus easy to interpret. Further, in the case of the misalignment shown in FIG. 19, the four vertical linear projections 4322, 4302, 4303, 4323 are no longer the same length. This combined dissymmetry of the worksurface projections provides the rotary tool user with an indication of misalignment (in this case the drill pointing to the right along the horizontal axis). This is detectable both before and during the drilling operation.

In other embodiments, the pattern projection produced can be a combination or derivative of the pattern projections disclosed. Other embodiments can also implement alternative projection patterns such as a triangular-type shape (comprised of three lines) versus the square-type shape (comprised of four lines) disclosed in FIG. 10. Moreover, a person having ordinary skill in the art can easily understand that many different types of alignment patterns can be produced through a combination of lasers and optics.

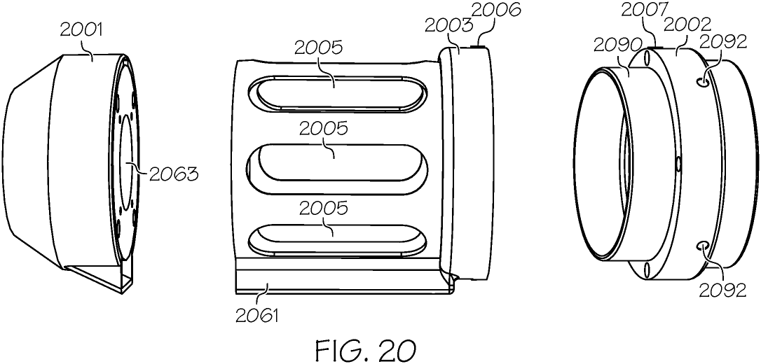

FIG. 20 depicts another embodiment that consists of three separate parts that can be easily connected to create a single operational unit with functionality and characteristics like those previously depicted and having further features . This embodiment includes a worksurface alignment device 2001, a spacer member 2003, and an adaptor 2002 which mounts permanently or temporarily onto the non-rotational part of a rotary tool. FIG. 20 depicts a side view of the three parts of the system as disconnected. Similar to the embodiments described above,, this embodiment also contains an open passage 2063 that allows a drill bit to rotate without obstruction.

While the embodiment depicted in FIG. 20 may optionally contain any of the features of the alignment devices described above, it also presents some additional advantages. The interchangeable middle spacer member 2003 allows the system to be fully customizable for any chuck diameter, length or shape. The three individual parts can therefore be mixed and matched to a create complete drill alignment system that operates with multiple combinations of drill, chuck, and operational boring requirements.

The three-part system depicted in FIG. 20 may connect and align in the manner similar to the two-part system depicted in FIG. 7. In various embodiments the three separate parts all connect and align with the use of magnets, a combination of magnets and mechanical means, or purely mechanical means. In other embodiments the three separate members connect and align with the use of magnets and ferrous materials with or without mechanical means. In yet another embodiment, the middle spacer member 2003 connects to the drill mounted adaptor device 2002 by means of magnets, while the worksurface alignment device 2001 connects to the middle spacer member 2003 via screws.

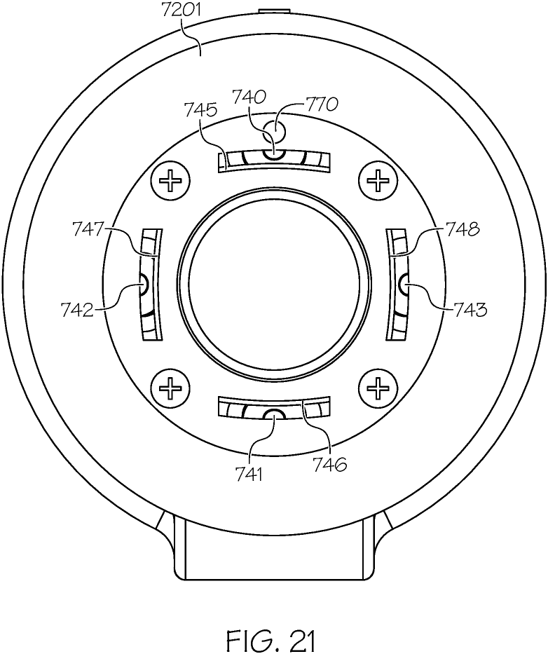

FIG. 21 depicts another alignment device 7201 that includes sensor 770 to enhance the functionality of the system. In this embodiment sensor 770 comprises a distance sensor for determining the distance from the alignment member to the worksurface and thus the depth of the drill bit during a drilling operation can be determined. In further embodiments additional or alternative sensors are provided including a temperature sensor for detecting and monitoring a drill bit or bore hole temperature during a drilling operation, a motion or rotational sensor to track the RPM of the drill bit or chuck, a motion and/or vibration sensor to track drill bit usage, a camera for automatically detecting the projected lines and determining alignment, a camera for recording an image or video of the drill operation or bore hole, a microphone for listening to the sound of the drilling operation or drill components, a thermal camera for determining bit or bore hole temperature levels, a sensor for visualizing subsurface obstructions or formations, a lidar or other sensor known in the art for obtaining and mapping the shape and or orientation of the worksurface, or a sensor for reporting drill status characteristics such as motor temperature.

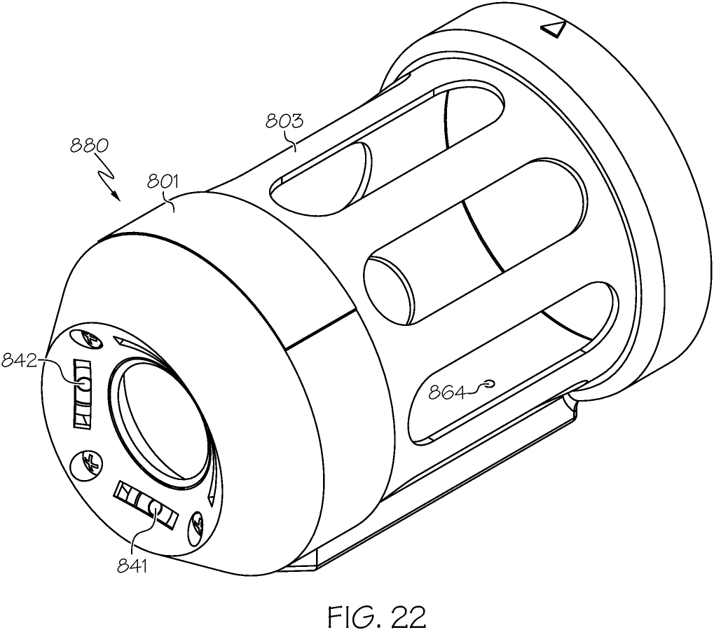

FIG. 22 depicts an embodiment with a chuck facing sensor 864 that is mounted within the spacer member 803. Chuck facing sensor 864 is used to detect one or more chuck related attributes, such as the chuck rotation speed (RPM), chuck rotation direction, chuck vibration characteristics. In another embodiment, the chuck facing sensor is mounted in or about an open passage.

Still referring to FIG. 22, in this embodiment the alignment member 800 includes a visible display 801. Display 801 can present data obtained from sensors as described above or from a wireless communication to the system. Display 801 includes a series of LED lights that will illuminate sensor output. In other embodiments the display is an LCD display, a segment display, an OLED display, a TFT display, an e-ink display of a digital display . In yet a further embodiment, the device incorporates an audible notification system that can provide audible cues or alarms to the user in response to sensor outputs.

In further embodiments, the alignment device or spacing member includes (1) a 3D orientation sensor for determining the orientation of the of overall system (and thus the drill) in space, (2) a position sensor for determining the location or coordinates of the system within a given area, and/or (3) a microphone for listening to the sound of the drilling operation or drill components. In embodiments, these sensors are integrated to a printed circuit board, such as printed circuit board 65 depicted in FIG. 7, that contains other electronic elements of the system including driver components.

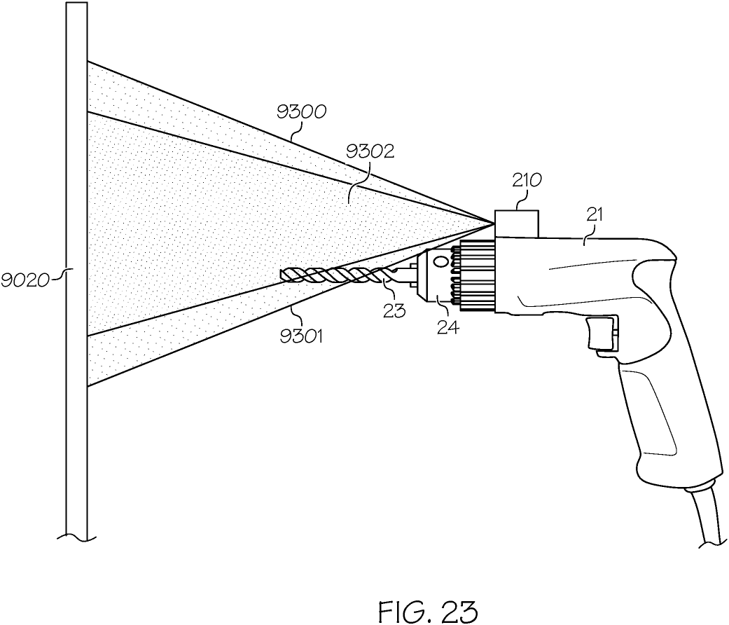

Now referring to FIG. 23, a further embodiment wherein alignment device 210 is mounted on a non-rotational part of a rotary tool 21 that is not concentric with the rotational axis defined by drill bit 23 of the rotary tool. In this embodiment, fan shaped projections 9300, 9301, 9302 and the functionality are similar to the previous embodiments, but the projected lines on the worksurface are no longer equally positioned around the rotational axis of the rotary tool, and instead are offset from the rotational axis of the rotary tool. In FIG. 23, the linear projections 9300, 9301, and 9302 are above the linear axis of the rotary tool from the viewpoint of the tool user. Not shown is a fourth linear projection opposite of fan shaped projection 9302.

The embodiment depicted in FIG. 23 may be mounted on any portion of a drill that is parallel with the drill bit. In another embodiment an adjustable mount is provided that can be attached to a wide variety of drill casings. In other embodiments the linear projection or projections originate from a single central point. As such the foregoing embodiment can use a single laser module projection and a diffractive optical element (DOE) or lens that produces the linear projections on a worksurface, such as those depicted in FIG. 10.

In yet another contemplated embodiment, similar to that depicted in FIG. 23, the alignment device is integrated within or built into the drill or drill battery as a standard feature. In this contemplated embodiment, the alignment device is therefore integrated within or built into the drill or drill battery in a manner similar to how many existing drills and/or drill batteries that have worksurface illumination systems.

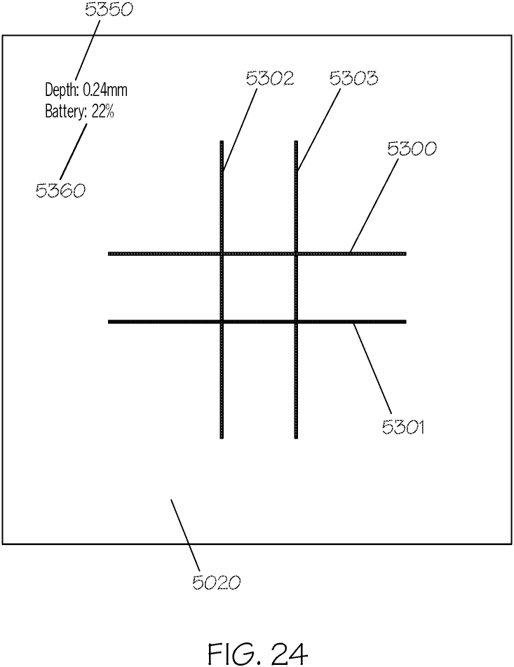

FIG. 24 depicts a projection from an alternative display embodiment that combines a worksurface alignment pattern along with additional information or data projected on the worksurface. The alignment pattern projected on worksurface 5020 is comprised of four linear projections 5300,5301, 5302, 5303 that jointly produce a grid pattern when aligned with the worksurface. Additionally, this embodiment includes information or data that is also projected onto the worksurface. This allows the operator to focus solely on the worksurface and is an alternative to the visible display surface 801 in the FIG. 22. In this embodiment the projected display includes two data elements: the drill bit depth 5350 and the remaining system battery power 5360. The projected display may also indicate any other type of data, such as data or information obtained from one or more system sensors, or data or information from wireless communication to the system. The projected display may be produced by a holographic micro display, or anything known in the art. Further, the projected display can be combined with any of the worksurface patterns.

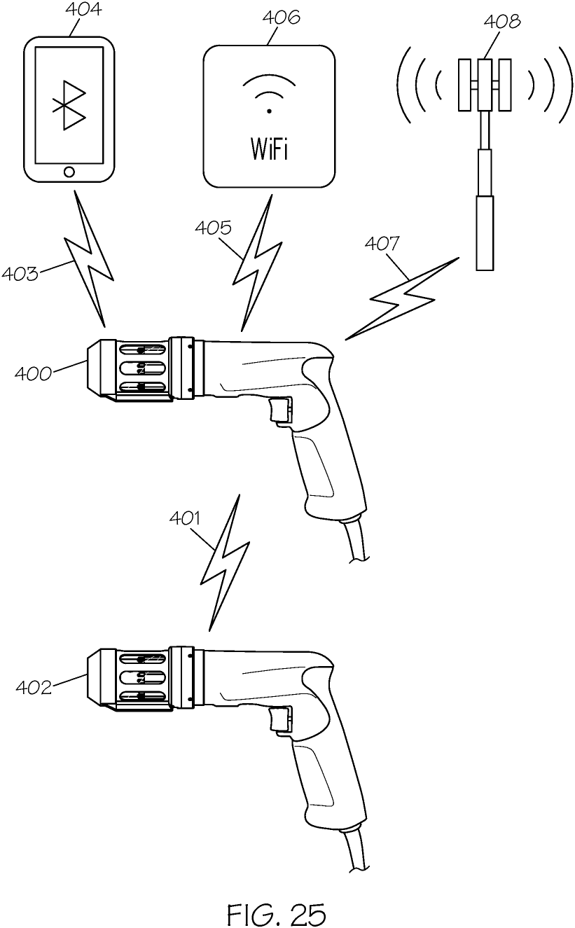

FIG. 25 depicts an alternative embodiment where the alignment device 400 contains a wireless communication transceiver. The wireless communication transceiver can use a Wi-Fi network communication protocol. In other embodiments other wireless communication technology is used including Bluetooth®, LoRa®, or cellular. As depicted in FIG. 25, wireless communication allows an alignment device 400 to communicate directly 401 with another peer device 402, directly 403 to a mobile smart phone 404, or directly 405 to a central network WIFI® router 406 device. In other embodiments, such as when cellular communications are integrated to the device, the alignment device 400 can communicate directly 407 to a cellular tower 408. In yet other embodiments, the alignment device 400 can communicate to one or more device on the same network, or even to an ad-hoc network of mesh connected devices. The wireless communication method, configurations and mechanism can be anything known in the art.

Wireless communication allows the alignment device to communicate and share information gathered by the system’s sensors with other wirelessly connected entities thereby allowing for remote monitoring of the drill activity. It also allows the system to receive information from any wireless source. Examples of wireless data sharing can include but are not limited to any of the following: the system may report the productivity of an operator to supervisor personnel based on the chuck rotation sensing over time, the system may report drill motor related anomalies to a technician, or the system may send an image of each drill hole to a server containing a machine learning algorithm that can automatically classify the hole as successful or flawed.

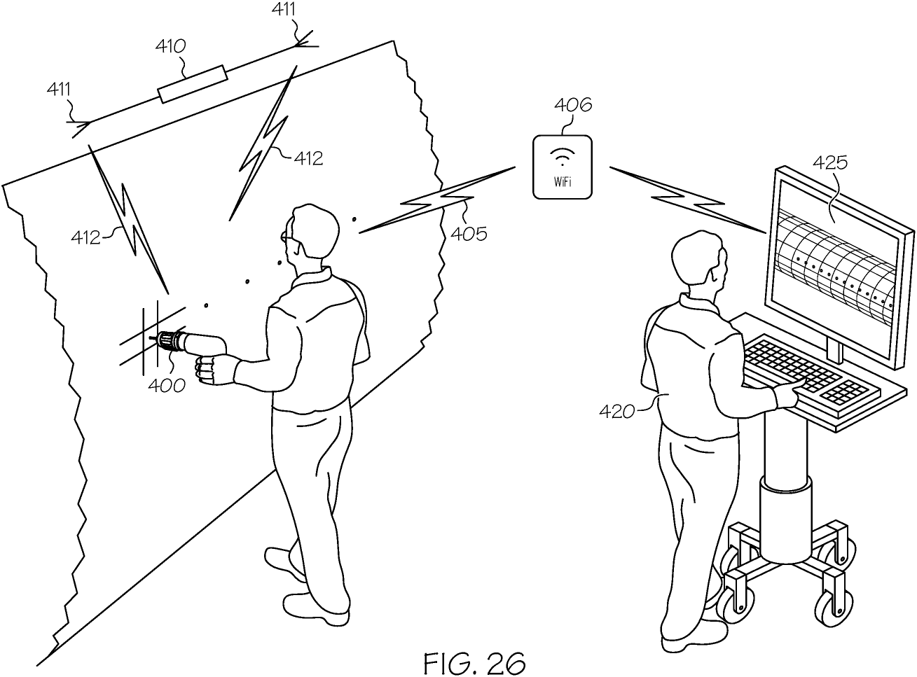

As depicted in FIG. 26, wireless communication can also be combined with a positioning reporting device or system that can communicate the location or coordinates of the device within a given area. In embodiments the positioning device and technology may be Bluetooth Low Energy (BLE), WIFI®, or GPS. BLE 5.1 is a specification aiming to improve accuracy in positioning and direction finding, which can be especially beneficial for indoor location services. The combination of BLE 5.1 (or greater) along with various system sensors can be used to wirelessly capture the position, orientation, and other factors related to the drill or operation at any time. BLE 5.1 exposes several indoor positioning methods including Angle of Arrival (AoA) and Angle of Departure (AoD), any of which known in the art can be utilized. In one example, applied to the aerospace manufacturing industry, a system device 400 can integrate a BLE 5.1 (or greater) member, one or more AoA Bluetooth receivers 410 with antennae 411 for capturing the position of the system device 400 via a Bluetooth signal 412, wireless communications 405 such as WiFi for transmitting position and data to a WiFi router 406, and various sensors to calculate and wirelessly communicate where and when drilling operations occurred on an airframe (a map of drill hole coordinates over time). A quality control engineer 420 or quality control algorithm then use this wirelessly transmitted mapping of drill coordinate data 425 to verify the completeness and/or grade of a given set of drilling operations. In another example, the system can be used to monitor and track the position and activities of each operator over time. This wirelessly gathered data can then be analyzed and used to improved operator tasking and efficiency.

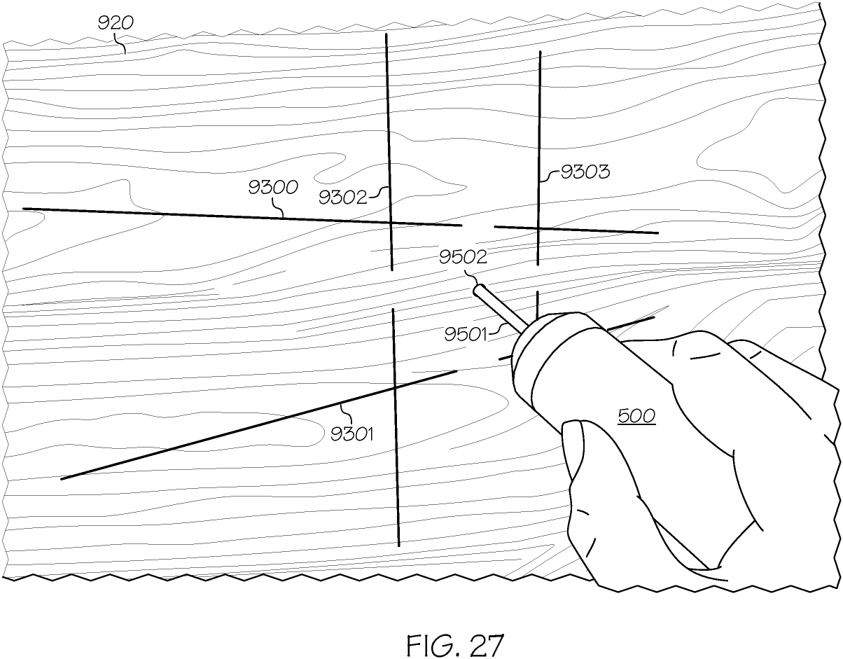

In yet another embodiment, any of the projection elements and/or sensors of the system can be incorporated into a stand-alone system, without a drill, that can be used to assess the accuracy of a drilled hole after completion. In one embodiment depicted in FIG. 27, an alignment device 500 includes lasers and optics to produce a pattern on the worksurface 920 as well as the necessary components such as a battery, electronics, and a means for toggling the laser projections on or off. Device 500 includes a shaft 9501 which emulates the diameter of a given drill bit. When shaft 9501, which is attached to and aligned with the body of device 500, is inserted into a completed drill hole 9502 of the same diameter in worksurface 920, the pattern projected on the worksurface indicates perpendicularity or alignment of the drill hole with regards to the worksurface 920. If the completed hole 9502 is perpendicular with the worksurface 920, the projected worksurface pattern could be any of the alignment patterns outlined in this specification reflecting such alignment, such as FIGS. 10 or 14. Conversely, if the completed hole 9502 is not perpendicular or misaligned with the worksurface 920, the projected worksurface pattern may reflect a misalignment patterns, such as those illustrated in FIGS. 11, 12, 15, and 16.

In FIG. 27 shaft 9501 is inserted into a completed drill hole 9502 that is angled to the left and thus not perpendicular to the worksurface 920. As a result of the non-perpendicular angled drill hole, the two horizontal linear projections 9300, 9301 are not parallel, which makes the projected grid non-symmetric and the center square trapezoidal. Further the two vertical linear projections 9302, 9303 are no longer the same length. This combined dissymmetry of the worksurface projections provides the user with an indication of misalignment of an existing drill bit hole.

Shaft 9501 is one of several in a set of shafts, each of which emulate the diameter of different drill bits and thus different diameter completed drill bit holes. In embodiments interchangeable shafts are provided which allows a single device to support many different diameter shafts. The shafts may also optionally include depth markers that can be used to measure the depth of a completed drill hole.

In another related embodiment, the alignment device, such as device 500 also includes worksurface facing sensors and a display to enhance the functionality of the system. In this embodiment the sensor (or optionally sensors) could be anything outlined in this specification or known in the art.

1. A visual alignment system for a rotary boring tool having a boring element wherein said boring element defines a rotational axis, said system comprising
an alignment device with a light source, said alignment device having an attachment element for engagement to a fixed part of said rotary boring tool and
said light source adapted to project a plurality of fan-shaped light beams from said light source, and
said projected beam create linear images on a worksurface, and said beams are angled with respect to said rotational axis.

2. The visual alignment system recited in claim 1 wherein said alignment device further comprises a plurality of light sources that project a plurality of substantially fan-shaped light beams towards a worksurface opposite, wherein when said beams impinge on a worksurface they create a linear image, and
said light sources project at least four beams,
a first pair of linear beams are projected on opposite sides of the said rotational axis and create parallel lines on a worksurface, and
a second pair of linear beams are projected on opposite sides of the said rotational axis and create parallel images on a worksurface to each other and perpendicular to said first pair of images.

3. The visual alignment system as recited in claim 1 wherein said light sources comprise lasers.

4. The visual alignment system as recited in claim 1 wherein said light source is mounted on an annular collar that is adapted for attachment to a fixed part of said rotary tool.

5. The visual alignment system as recited in claim 4 wherein said annular collar is adapted to be attached to said rotary boring tool using a magnet.

6. The visual alignment system of claim 4 further comprising an adaptor, said adaptor comprising an annular ring that has a first side adapted to attach to a fixed portion of a rotary tool and an opposite side adapted to attach to said alignment member.

7. The visual alignment system as recited in claim 1 further comprising a plurality of beam splitting optic devices, wherein each beam projection is split into two fan shaped beams, wherein said first split beam is projected at a fixed angle with reference to said rotational axis and said second split beam is projected at a second fixed angle with refence to said rotational axis,
and when said rotary boring tool is perpendicular to said worksurface a first linear image created by said first beam is parallel to a said second linear image created by said second beam on said worksurface.

8. The visual alignment system as recited in claim 7 wherein said light sources and beam splitter optics create eight linear beams, wherein when said boring member is perpendicular to said worksurface, four linear images are substantially parallel to each other, and four linear images are perpendicular to each other.

9. The visual alignment system of claim 7 wherein said the beam splitting optic devices is selected from a group comprising a beam splitter, a prism, a lens, a mirror, a diffractive optical element, and a diffractive grating.

10. The visual alignment system of claim 1 further comprising a sensor and a feedback system, wherein in response to data from said sensor, said feedback system provides a signal that relates to said data.

11. The system of claim 10 wherein said sensor measures a distance of penetration of said boring element into said work surface and said signal relates to said distance.

12. The visual alignment system of claim 10 further comprising a camera and a feedback system, said camera directed to said worksurface and adapted to record a drilling operation.

13. The visual alignment system of claim 10 wherein said sensor is selected from a group comprising a lidar, radar or sonar, and said sensor detects worksurface characteristics.

14. The visual alignment system of claim 10 wherein said feedback system comprises a visual display.

15. The visual alignment system of claim 10 wherein said feedback system comprises an audio signal.

16. The visual alignment system of claim 10 wherein said sensor comprising an electromagnetic sensor and a feedback system, said electromagnetic sensor directed at a rotational member of the rotary boring element and adapted to capture information about operation of the rotary tool.

17. The visual alignment system of claim 10 further comprising an inertial measurement sensor selected from a group consisting of an accelerometer, gyroscope, magnetometer, and combination thereof, wherein inertial measurement sensor measures the orientation of the visual alignment system.

18. The visual alignment system of claim 10 further comprising a wireless communication system that can communicate data from said sensors wirelessly to a central control station.

19. A device for the detection of the characteristics of a bore hole, said device comprising a body, said body and a central shaft extending from said body, wherein said body comprises an alignment device and said alignment device comprises a light source, wherein said light source is adapted to project fan-shaped beams onto a worksurface to create linear images, wherein a first pair of beam linear images is parallel to one another and a second pair of beam linear images is perpendicular to said first pair, and each said of said beams are projected from a location concentric around said linear shaft.

20. A rotary tool having a visual alignment system comprising a motor, a boring element driven by said motor, and wherein said boring element defines a rotational axis, and
an alignment device, said alignment device comprising a light source provided on a fixed part of said tool and adapted to project a plurality of fan-shaped light beams and
said projected beams create linear images on a worksurface, and
said beams are angled with respect to said rotational axis of said rotary tool.
